(19) United States
(12) Patent Application Publication
(10) Pub. No.: US 2010/0241679 A1
(43) Pub. Date: Sep. 23, 2010

(54) SIGNAL CONVERSION SYSTEMS

(76) Inventor: Guo Xing LI, Sunnyvale, CA (US)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 12/405,541

(22) Filed: Mar. 17, 2009

(51) Int. Cl. G06F 7/58; G06F 7/50

(52) U.S. Cl. 708/250; 708/670

(57) ABSTRACT

A signal conversion system includes a compensation module and a conversion module coupled to the compensation module. The compensation module is operable for adjusting a first compensation signal according to a dynamic signal and adding the first compensation signal to a first input signal. The compensation module is also operable for subtracting a second compensation signal, indicative of an accumulation of the dynamic signal, from the output signal. The conversion module is operable for receiving a second input signal that is the sum of the first input signal and the first compensation signal, and converting the second input signal to the output signal.

### BACKGROUND

Sigma-delta modulation is a method for encoding high resolution signals into lower resolution signals by using noise shaping and error feedback. By using such techniques, a sigma-delta converter (e.g., an analog to digital converter, a digital to analog converter) can relatively easily achieve very high resolutions while using low cost analog components. However, conventional sigma-delta converters may have some issues, e.g., idle tone issues, flat zone issues, etc. For example, if the input signal of the conventional sigma-delta converter is a DC (direct current) input, e.g., the input signal has a constant level, then the sigma-delta converter may generate a pattern noise (an idle tone) which can interfere with the output of the converter. In addition, if the input signal has a level that varies in a relatively small range near a specific level, the output of the converter may have a substantially constant level which will not vary as the input signal varies, such that the output may have relatively serious errors. Such a relatively small range can be called a flat zone or a dead zone. The specific level is determined by the nature of the sigma-delta converter. For example, the specific level can have values 0V, ±(½)V_{REF}, ±(⅓)V_{REF} and so on. V_{REF} is a reference level for the operation of the sigma-delta converter.

### SUMMARY

In one embodiment, a signal conversion system includes a compensation module and a conversion module coupled to the compensation module. The compensation module can adjust a first compensation signal according to a dynamic signal and add the first compensation signal to a first input signal. The compensation module can also subtract a second compensation signal, indicative of an accumulation of the dynamic signal, from an output signal. The conversion module can receive a second input signal that is the sum of the first input signal and the first compensation signal, and convert the second input signal to the output signal.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 depicts a block diagram of an example of a signal conversion system, in accordance with one embodiment of the present invention.

FIG. 2 depicts a block diagram of an example of a signal conversion system, in accordance with one embodiment of the present invention.

FIG. 3 depicts a block diagram of an example of a signal conversion system, in accordance with one embodiment of the present invention.

FIG. 4 depicts a flowchart of examples of operations performed by a signal conversion system, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “adjusting,” “adding,” “subtracting,” “converting,” “calculating,” “generating,” “comparing,” “accumulating,” “receiving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

In one embodiment, a signal conversion system is provided. In one such embodiment, the signal conversion system can convert an input signal to an output signal. By applications of signal dithering, the output signal can indicate the input signal relatively accurately. More specifically, the input signal can be added to a dither signal, e.g., a pseudorandom signal, so as to be relatively busy. In addition, a compensation signal, indicative of an equivalent level of the dither signal, can be subtracted from the output signal so as to indicate the input signal properly. As a result, idle tone issues and flat zone issues can be reduced, and meanwhile the signal conversion system can generate the output signal to indicate the input signal properly.

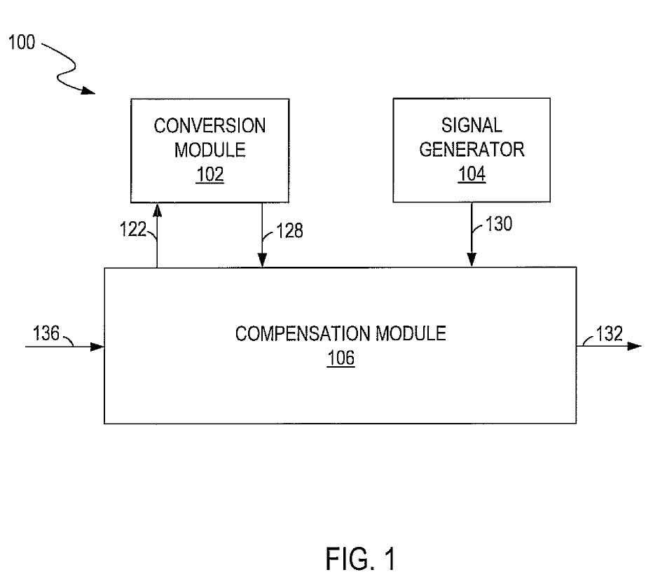

FIG. 1 depicts a block diagram of an example of a signal conversion system 100, in accordance with one embodiment of the present invention. As shown in FIG. 1, the signal conversion system 100 includes a conversion module 102, a signal generator 104, and a compensation module 106.

In one embodiment, the signal generator 104 can be used to generate a dynamic signal 130. The compensation module 106 coupled to the signal generator 104 can adjust a first compensation signal (not shown in FIG. 1) according to the dynamic signal 130. The compensation module 106 can also add the first compensation signal to a first input signal, e.g., an input signal 136, and subtract a second compensation signal (not shown in FIG. 1), indicative of an accumulation of the dynamic signal 130, from an output signal 128. The conversion module 102 coupled to the compensation module 106 can receive a second input signal, e.g., an input signal 122, from the compensation module 106, and convert the input signal 122 to the output signal 128. In one embodiment, the input signal 122 is the sum of the input signal 136 and the first compensation signal.

More specifically, in one embodiment, the conversion module 102 includes an ADC (analog to digital converter), e.g., a sigma-delta ADC, for converting an analog signal 122 to a digital signal 128. The compensation module 106 can provide the analog signal 122, which is equal to the first compensation signal plus the input signal 136, to the sigma-delta ADC 102, and can generate an output signal 132 that is equal to the output signal 128 minus the second compensation signal. The first compensation signal can be, but is not limited to, an analog signal. The second compensation signal can be, but is not limited to, a digital signal.

Advantageously, the dynamic signal 130 can be a pseudorandom signal. The first compensation signal, adjusted according to the pseudorandom signal 130, can be used as a dither signal for the sigma-delta ADC 102. Thus, the input signal 122 of the sigma-delta ADC 102 can be relatively busy. For example, a level of the input signal 122 will not be substantially constant or will not vary in a relative small range. As a result, idle tone and flat zone issues of the sigma-delta ADC 102 can be reduced, and so can the output errors of the output signal 128.

In one embodiment, an accumulation result of the output signal 128 indicates, e.g., is proportional to, an equivalent level of the input signal 122. For example, the output signal 128 can include a string of serial digital signals, each of which represents a corresponding value. An accumulation result of the output signal 128 can be obtained by accumulating a plurality of values corresponding to the serial digital signals. The operations for the accumulation are described in more detail below. In addition, an accumulation result of the second compensation signal can indicate, e.g., be proportional to, an equivalent level of the first compensation signal. Since the output signal 132 can be equal to the output signal 128 minus the second compensation signal, an accumulation result of the output signal 132 can indicate, e.g., be proportional to, an equivalent level of the input signal 136.

In another embodiment, a value of the output signal 128 indicates, e.g., is proportional to, an equivalent level of the input signal 122. In addition, a value of the second compensation signal can indicate, e.g., be proportional to, an equivalent level of the first compensation signal. Thus, in one such embodiment, a value of the output signal 132 can indicate, e.g., be proportional to, an equivalent level of the input signal 136.

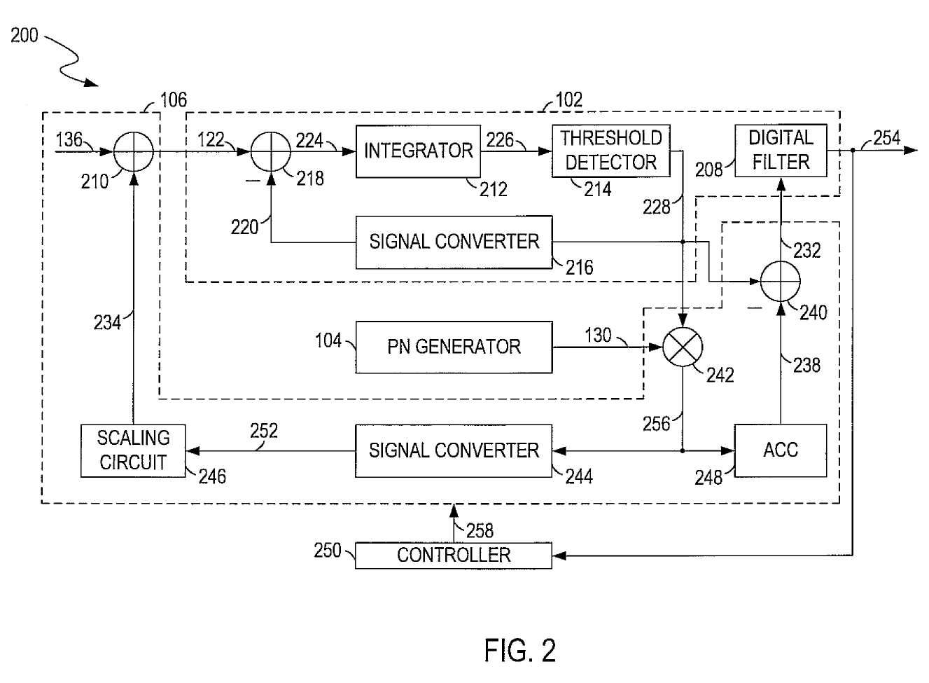

FIG. 2 depicts a block diagram of an example of a signal conversion system 200, in accordance with one embodiment of the present invention. Elements that are labeled the same as in FIG. 1 have similar functions and will not be repetitively described herein. In the example of FIG. 2, the conversion module 102 can convert the input signal 136 to an output signal 228. In one embodiment, the output signal 128 in FIG. 1 includes the output signal 228 in FIG. 2. For example, the compensation module 106 can add a first compensation signal 234 to the input signal 136 and subtract a second compensation signal 238 from the output signal 228.

As shown in FIG. 2, the conversion module 102 includes a sigma-delta ADC. More specifically, the sigma-delta ADC 102 can include an integrator 212, a threshold detector 214 and a signal converter 216. The integrator 212 can be used to integrate a first signal 224 calculated according to the input signal 122 and a second signal 220, and to generate an integral signal 226 according to the integration. For example, a subtracter 218 can subtract the second signal 220 from the input signal 122, so as to provide the first signal 224 to the integrator 212. The integrator 212 can generate the integral signal 226 having a level V₂₂₆ indicative of, e.g., proportional to, an integral value ∫V₂₂₄dt of the first signal 224. In one embodiment, when the first signal 224 has a positive level V₂₂₄, a level V₂₂₆ of the integral signal 226 can increase. On the other hand, when the first signal 224 has a negative level V₂₂₄, the integral signal level V₂₂₆ can decrease.

In one embodiment, the threshold detector 214 is coupled to the integrator 212, and is operable for comparing the level V₂₂₆ of the integral signal 226 with a predetermined threshold V_{PRE}, and for generating the output signal 228 according to the comparison. In one embodiment, the predetermined threshold V_{PRE} is optional. For example, the predetermine threshold V_{PRE} can be, but is not limited to, 0V. In one embodiment, if the level V₂₂₆ is not greater the threshold V_{PRE}, the threshold detector 214 can generate an output signal 228 having a first level V_{L}. The first level V_{L} can be, but is not limited to, a low voltage level (e.g., 0V). The low voltage level V_{L} can be used as a digital logic signal “0”. If the level V₂₂₆ is greater than the threshold V_{PRE}, the threshold detector 214 can generate an output signal 228 having a second level V_{H}. The second level V_{H} can be, but is not limited to, a high voltage level (e.g., 1V) that is higher than the low voltage level V_{L}. The high voltage level V_{H} can be used as a digital logic signal “1”.

In one embodiment, the threshold detector 214 is a 1-bit quantizer that quantizes the integral signal level V₂₂₆. The 1-bit quantizer 214 can include a clocked comparator. More specifically, the clocked comparator can be triggered by a clock signal CLK with a predetermined frequency f_{PRE}. When the clocked comparator is triggered by the clock signal CLK, the clocked comparator can generate the output signal 228 according to the result of the comparison between the level V₂₂₆ and the predetermined threshold V_{PRE}. For example, if the level V₂₂₆ is greater than the threshold V_{PRE} when the threshold detector 214 is triggered by the clock signal CLK, the threshold detector 214 can output a digital signal “1” for a predetermined clock period T_{PRE}, e.g., T_{PRE}=1/f_{PRE}. On the other hand, if the level V₂₂₆ is not greater than the threshold V_{PRE}, the threshold detector 214 can output a digital signal “0” for a clock period T_{PRE}.

In one embodiment, the signal converter 216 is coupled to the threshold detector 214, and is operable for providing the second signal 220 and for adjusting a level V₂₂₀ of the second signal 220 according to the output signal 228. The signal converter 216 can be, but is not limited to, a 1-bit DAC (digital to analog converter) that converts a digital signal, e.g., the output signal 228, to an analog signal, e.g., the second signal 220.

More specifically, in one embodiment, when the output signal 228 is a digital signal “0”, the signal converter 216 can adjust the second signal 220 to a negative reference level −V_{R}, e.g., V₂₂₀=−V_{R}. As such, a level V₂₂₄ of the first signal 224 can be given by V₂₂₄=V₁₂₂+V_{R}, where V₁₂₂ is a level of the input signal 122. The reference level V_{R} can be positive, e.g., +1V, and can be determined by an absolute value |V₁₂₂| of the level V₁₂₂. More specifically, if V_{MAX} is a maximum value of the absolute value |V₁₂₂|, the maximum value V_{MAX} can be less than the reference level V_{R}, e.g., |V₁₂₂|<V_{MAX}<V_{R}. For example, if the reference level V_{R} is equal to 1V, the level V₁₂₂ can be equal to −0.2V, 0.5V, −0.6V, 0.99V, etc. Thus, the level V₂₂₄ that is equal to V₁₂₂+V_{R} can be positive, and the integral signal level V₂₂₆ can increase. In one embodiment, when the output signal 228 is a digital signal “1”, the signal converter 216 can adjust the second signal 220 to a positive reference level V_{R}, e.g., V₂₂₀=V_{R}. As such, the level V₂₂₄ of the first signal 224 can be given by V₂₂₄=V₁₂₂−V_{R}, and so as to be negative. Thus, the integral signal level V₂₂₆ can decrease.

Consequently, by integrating the first signal 224 and comparing the integral signal level V₂₂₆ with the threshold V_{PRE}, the sigma-delta ADC 102 can generate a plurality of digital signals 228 at the predetermined frequency f_{PRE}. The digital signals 228 can be used to obtain the level V₁₂₂ of the input signal 122.

In one embodiment, the integration of the first signal 224 includes the integration of the input signal 122 and the integration of the second signal 220. For example, an integral value ∫V₂₂₄dt of the first signal 224 can be given by:

∫V₂₂₄dt=∫V₁₂₂dt−∫V₂₂₀dt, (1)

where ƒV₁₂₂dt is an integral value of the input signal 122, and ∫V₂₂₀dt is an integral value of the second signal 220.

In one embodiment, the output signal 228 can be sampled by a digital filter 208. During a sampling period T_{SAM}, the digital filter 208 can sample the output signal 228 at the predetermined frequency f_{PRE} for N_{SAM} times, e.g., T_{SAM}=T_{PRE}×N_{SAM}. In addition, during the sampling period T_{SAM}, V_{EQ224} can be an equivalent level of the first signal 224, and V_{EQ122} can be an equivalent level of the input signal 122. Thus, an integral value

$${\int }_{0}^{{T}_{SAM}} {V}_{224} d t$$

of the first signal 224 can be given by:

$${\int }_{0}^{{T}_{SAM}} {V}_{224} d t = {N}_{SAM} \times {T}_{PRE} \times {V}_{EQ 224} , \qquad ( 2 )$$

and an integral value

$${\int }_{0}^{{T}_{SAM}} {V}_{122} d t$$

of the input signal 122 can be given by:

$${\int }_{0}^{{T}_{SAM}} {V}_{122} d t = {N}_{SAM} \times {T}_{PRE} \times {V}_{EQ 122} . \qquad ( 3 )$$

During the sampling period T_{SAM}, N₀ can be a number of the digital signals “0” received by the digital filter 208 from the threshold detector 214, and N₁ can be a number of the digital signals “1” received by the digital filter 208 from the threshold detector 214. The number N_{SAM} can be equal to N₀ plus N₁, e.g., N_{SAM}=N₀+N₁. As such, the integrator 212 can integrate the positive level V₁₂₂+V_{R} for N₀ clock periods T_{PRE} and integrate the negative level V₁₂₂−V_{R} for N₁ clock periods T_{PRE}. Thus, an integral value

$${\int }_{0}^{{T}_{SAM}} {V}_{220} d t$$

of the second signal 220 can be given by:

$${\int }_{0}^{{T}_{SAM}} {V}_{220} d t = ( {N}_{1} - {N}_{0} ) \times {T}_{PRE} \times {V}_{R} . \qquad ( 4 )$$

According to equation (1), the following equation can be obtained:

$${\int }_{0}^{{T}_{SAM}} {V}_{224} d t = {\int }_{0}^{{T}_{SAM}} {V}_{122} d t - {\int }_{0}^{{T}_{SAM}} {V}_{220} d t . \qquad ( 5 )$$

Equations (2), (3) and (4) can be substituted into equation (5) to obtain the following equation:

N_{SAM}×T_{PRE}×V_{EQ224}=N_{SAM}×T_{PRE}×V_{EQ122}−(N₁−N₀)×T_{PRE}×V_{R}. (6a)

Equation (6a) can be rewritten as:

V_{EQ224}=V_{EQ122}−(N₁−N₀)×V_{R}/N_{SAM}. (6b)

In one embodiment, since the integration of the first signal 224 is adjusted by comparing the integral signal level V₂₂₆ with the threshold V_{PRE}, and the level V₂₂₄ of the first signal 224 can vary within a range, e.g., from −2V_{R} to 2V_{R}, the integral signal level V₂₂₆ can vary in a finite range which is determined by the threshold V_{PRE} and the level V_{R}. Thus, the integral value

$${\int }_{0}^{{T}_{SAM}} {V}_{224} d t$$

of the first signal 224 also can vary in a finite range. In one embodiment, the sampling period T_{SAM} can be long enough, such that the equivalent level V_{EQ224} that is equal to

$$( 1 / {T}_{SAM} ) {\int }_{0}^{{T}_{SAM}} {V}_{224} d t$$

can be substantially equal to zero. Consequently, equation (6b) can be rewritten as:

0=V_{EQ122}−(N₁−N₀)×V_{R}/N_{SAM}. (7)

Thus, the following equations can be obtained:

N₁−N₀=N_{SAM}×V_{EQ122}/V_{R}; and (8a)

V_{EQ122}=V_{R}×(N₁−N₀)/N_{SAM}. (8b)

As such, in one embodiment, the value N₁−N₀ is proportional to the equivalent level V_{EQ122} of the input signal 122.

In one embodiment, the value N₁−N₀ can be obtained by using a DDC (digital to digital converter) and an accumulator (not shown in FIG. 2). For example, the DDC can convert the digital signal 228 to a signed digital signal, e.g., a signed binary code. When the digital signal 228 is “1”, the corresponding signed digital signal can be “+1”. When the digital signal 228 is “0”, the corresponding signed digital signal can be “−1”. The accumulator can receive a plurality of signed digital signals, e.g., “+1”, “−1”, from the DDC and generate the value N₁−N₀ by accumulating the signed digital signals. The DDC can be, but not necessarily, implemented in the digital filter 208. The accumulator can be, but not necessarily, implemented in the digital filter 208.

Consequently, in one embodiment, the digital filter 208 can calculate the value N₁−N₀ by accumulating the digital signal 228. In one embodiment, an accumulation result of the digital signal 228 is equal to N₁−N₀. The digital filter 208 can generate a digital signal 254 according to the value N₁−N₀, and for representing the equivalent level V_{EQ122} of the input signal 122. In one embodiment, the sampling period T_{SAM} can be relatively short such that the level V₁₂₂ can be equal to the equivalent level V_{EQ122}. In one embodiment, the digital filter 208 generates a multi-bit (e.g., 8-bit) parallel digital signal 254 indicative of the level V₁₂₂. In one embodiment, the digital filter 208 is a low pass digital filter for eliminating high frequency noises mixed in the output signal 228, such that the digital signal 254 can indicate the input signal 122 relatively accurately.

In one embodiment, the signal generator 104 can be a pseudorandom signal generator that generates the dynamic signal 130. For example, the pseudorandom signal generator 104 can be a PN (pseudorandom number) generator that generates a plurality of PNs 130. In other words, the dynamic signal 130 can include a PN. In one embodiment, a level V₂₃₄ of the first compensation signal 234 is adjusted according to a corresponding PN 130. Advantageously, by application of the second compensation signal 238, an output signal, e.g., the digital signal 254, of the signal conversion system 200 will not be influenced by the PNs 130, and can indicate the input signal 136 of the signal conversion system 200 properly, in one embodiment. Thus, the PN generator 104 can be, but is not limited to be, a low quality random number generator, so as to simplify the design of the PN generator 104 and reduce the cost of the PN generator 104. For example, the PN generator 104 can be a 1-bit digital signal generator. The plurality of PNs can be 1-bit digital signals, e.g., including digital signals “0” and “1”. In one embodiment, the PN generator 104 is realized by an LFSR (linear feedback shift register). For example, a relatively great amount of PNs can be stored in the LFSR, such that the LFSR can generate a plurality of PNs 130 properly by shifting the stored PNs out in a serial form.

In one embodiment, the compensation module 106 includes a signal converter 244. The signal converter 244 can be used to provide the first compensation signal 234 and to adjust a level V₂₃₄ of the first compensation signal 234 according to a corresponding PN of the PNs 130. More specifically, an exclusive OR gate 242 can be coupled between the PN generator 130 and the threshold detector 214, and be operable for generating a PN 256 having a digital value D₂₅₆. The digital value D₂₅₆ can be given by D₂₅₆=D₁₃₀ XOR D₂₂₈, where D₁₃₀ is a digital value of the PN 130, and D₂₂₈ is a digital value of the output signal 228.

In one embodiment, the signal converter 244 is a 1-bit DAC for converting a digital signal, e.g., the PN 256, to an analog signal, e.g., a compensation signal 252. Similar to the operation of the signal converter 216, when the PN 256 is a digital signal “0”, the signal converter 244 can adjust the compensation signal 252 to a negative reference level −V_{R}. When the PN 256 is a digital signal “1”, the signal converter 244 can adjust the compensation signal 252 to a positive reference level V_{R}. The signal converters 244 and 216 can be, but not necessarily, coupled to the same reference source having the level V_{R}, so as to simplify the circuit design of the signal conversion system 200.

The compensation module 106 can further include a scaling circuit 246 for scaling the compensation signal 256 down to the first compensation signal 234. For example, by using the scaling circuit 246, the level V₂₃₄ of the first compensation signal 234 can be given by:

V₂₃₄=V₂₅₆/M_{ACC}=±V_{R}/M_{ACC}, (9)

where V₂₅₆ is a level of the compensation signal 256, e.g., V₂₅₆=±V_{R}. In one embodiment, M_{ACC} can be, but is not limited to, a natural number (e.g., 16, 32, 64). As such, the first compensation signal 234 can be a pseudorandom signal having either a positive level V_{R}/M_{ACC} or a negative level −V_{R}/M_{ACC}.

Advantageously, the pseudorandom signal 234 can keep the input signal 122 of the sigma-delta ADC 102 relatively busy, so as to reduce idle tone issues and flat zone issues. For example, an adder 210 can add the pseudorandom signal 234 to the input signal 136, so as to generate the relatively busy input signal 122 to the sigma-delta ADC 102. In one embodiment, the level V₁₂₂ of the input signal 122 can be given by:

V₁₂₂=V₁₃₆+V₂₃₄=V₁₃₆±V_{R}/M_{ACC}, (10)

where V₁₃₆ is a level of the input signal 136. According to equations (1) and (10), the following equation can be obtained:

∫V₂₂₄dt=∫V₁₃₆dt−∫V₂₂₀dt+˜V₂₃₄dt, (11)

where ∫V₁₃₆dt is an integral value of the input signal 136, and ∫V₂₃₄dt is an integral value of the pseudorandom signal 234.

In one embodiment, when the PN 256 received by the signal converter 244 is a digital signal “1”, the pseudorandom signal 234 can be at the positive level V_{R}/M_{ACC} for a clock period T_{PRE}. Thus, the integrator 212 can integrate the positive level V_{R}/M_{ACC} for a clock period T_{PRE}, and the integral value can be indicated by T_{PRE}×V_{R}/M_{ACC}. Similarly, when the PN 256 received by the signal converter 244 is a digital signal “0”, the pseudorandom signal 234 can be at the negative level −V_{R}/M_{ACC} for a clock period T_{PRE}. Thus, the integrator 212 can integrate the negative level −V_{R}/M_{ACC} for a clock period T_{PRE}, and the integral value can be indicated by −T_{PRE}×V_{R}/M_{ACC}.

In one embodiment, during the sampling period T_{SAM}, the exclusive OR gate 242 can output a number N′₁ of digital signals “1” and a number N′₀ of digital signals “0”. As such, an integral value

$${\int }_{0}^{{T}_{SAM}} {V}_{234} d t$$

of the pseudorandom signal 234 can be given by:

$${\int }_{0}^{{T}_{SAM}} {V}_{234} d t = ( {N}_{1}^{′} - {N}_{0}^{′} ) \times {T}_{PRE} \times {V}_{R} / {M}_{ACC} , \qquad ( 12 )$$

In one embodiment, V_{EQ136} is an equivalent level of the input signal 136 during the sampling period T_{SAM}. Thus, an integral value

$${\int }_{0}^{{T}_{SAM}} {V}_{136} d t$$

of the input signal 136 can be given by:

$${\int }_{0}^{{T}_{SAM}} {V}_{136} d t = {N}_{SAM} \times {T}_{PRE} \times {V}_{EQ 136} . \qquad ( 13 )$$

According to equations (11), the following equation can be obtained:

$${\int }_{0}^{{T}_{SAM}} {V}_{224} d t = {\int }_{0}^{{T}_{SAM}} {V}_{136} d t - {\int }_{0}^{{T}_{SAM}} {V}_{220} d t + {\int }_{0}^{{T}_{SAM}} {V}_{234} d t . \qquad ( 14 )$$

Equations (2), (12) and (13) can be substituted into equation (14) to obtain the following equation:

N_{SAM}×T_{PRE}×V_{EQ224}=N_{SAM}×T_{PRE}×V_{EQ136}−(N₁−N₀)×T_{PRE}×V_{R+(}N′₁−N′₀)×T_{PRE}×V_{R}/M_{ACC} (15a)

Equation (15a) can be rewritten as:

V_{EQ224}=V_{EQ136}−(N₁−N₀)×V_{R}/N_{SAM}+(N′₁−N′₀)×V_{R}/(M_{ACC}×N_{SAM}). (15b)

As mentioned above, the equivalent level V_{EQ224} can be substantially equal to zero, therefore equation (15b) can be rewritten as:

0=V_{EQ136}−(N₁−N₀)×V_{R}/N_{SAM}+(N′₁−N′₀)×V_{R/}(M_{ACC}×N_{SAM}) (16)

As such, the following equations can be obtained:

N₁−N₀=−N_{SAM}×V_{EQ136}/V_{R}+(N′₁−N′₀)/M_{ACC}; and (17a)

V_{EQ136}=V_{R}×[(N₁−N₀)−(N′₁−N′₀)/M_{ACC}]/N_{SAM}. (17b)

In one embodiment, equations (17a) and (17b) can be rewritten as:

N₁−N₀=N_{SAM}×V_{EQ136}/V_{R}+K/M_{ACC}; and (18a)

V_{EQ136}=V_{R}×[(N₁−N₀)−K]/N_{SAM}, (18b)

where K is an integer determined by the difference between the numbers N′₁ and N′₀. More specifically, K′ can be a nonnegative integer (e.g., 0, 1, 2 . . . ). If the difference value N′₁−N′₀ is ranged from K′×M_{ACC} to (K′+1)×M_{ACC}, the integer K can be equal to the nonnegative integer K′. If the difference value N′₁−N′₀ is ranged from −(K′+1)×M_{ACC} to −K′×M_{ACC}, the integer K can be equal to the nonpositive integer −K′.

For example, when the difference between the numbers N′₁ and N′₀ is greater than −M_{ACC} and less than M_{ACC}, e.g., |N′₁−N′₀|/M_{ACC}<1, the integer K can be zero. In other words, when the absolute value of (N′₁−N′₀)/M_{ACC} is less than 1, the integral value

$${\int }_{0}^{{T}_{SAM}} {V}_{234} d t$$

of the pseudorandom signal 234 will not be large enough to influence an accumulation result N₁−N₀ of the output signal 228, in one embodiment. As such, the equivalent level V_{EQ136} of the input signal 136 can be obtained properly by accumulating the output signal 228. For example, according to equation (18b), the equivalent level V_{EQ136} can be given by V_{EQ136}=V_{R}×(N₁−N₀)/N_{SAM}.

However, in one embodiment, the difference N′₁−N′₀ is not greater than −M_{ACC} or not less than M_{ACC}, e.g., |N′₁−N′₀|/M_{ACC}≧1, such that the integer K can be nonzero (e.g., K=±1, ±2 . . . ). In other words, the integration of the pseudorandom signal 234 can influence the accumulation result N₁−N₀ of the output signal 228, in one embodiment. Advantageously, the compensation module 106 can further include an ACC (accumulator) 248 for accumulating a plurality of PNs 256. The ACC 248 can generate the second compensation signal 238 when a result of the accumulation reaches a predetermined value, e.g., M_{ACC}, −M_{ACC}. By using the second compensation signal 238, the equivalent level V_{EQ136} of the input signal 136 can be obtained properly.

More specifically, the second compensation signal 238 can be a carry signal. The carry signal 238 can include a signed digital signal, e.g., a signed binary code, having a value “+1”, “0”, or “−1”. A separate DDC (not shown in FIG. 2) can be implemented inside or outside the ACC 248 to convert the PNs 256 to a plurality of signed digital signals, respectively. When the PN 256 is a digital signal “1”, the corresponding signed digital signal can be “+1”. When the PN 256 is a digital signal “0”, the corresponding signed digital signal can be “−1”. In one embodiment, the ACC 248 can accumulate the PNs 256 by accumulating the corresponding signed digital signals of the PNs 256. As such, an accumulation result of the PNs 256 can be equal to N′₁−N′₀.

When the accumulation result N′₁−N′₀ is ranged between the values −M_{ACC} and M_{ACC}, e.g., −M_{ACC}<N′₁−N′₀<M_{ACC}, the signed digital signal 238 can be “0”. When the accumulation result N′₁−N′₀ reaches the value M_{ACC}, e.g., N′₁−N′₀=M_{ACC}, the ACC 248 can generate a signed digital signal 238 that is “+1” for a clock period T_{PRE}. When the clock period T_{PRE} expires, the ACC 248 can reset the signed digital signal 238 to “0” and re-accumulate the PNs 256. Similarly, when the accumulation result N′₁−N′₀ reaches the value −M_{ACC}, e.g., N′₁−N′₀=−M_{ACC}, the ACC 248 can generate a signed digital signal that is “−1” for a clock period T_{PRE}. When the clock period T_{PRE} expires, the ACC 248 can reset the signed digital signal 238 to “0” and re-accumulate the PNs 256.

In one embodiment, the aforementioned DDC (for converting the output signal 228 to the signed digital signal) is coupled to or implemented in a subtracter 240. In one embodiment, by subtracting the signed digital signal 238 from the signed digital signal indicative of the output signal 228, the subtracter 240 can generate an output signal 232. In one embodiment, the output signal 132 in FIG. 1 includes the output signal 232 in FIG. 2. The output signal 232 can be a signed digital signal having a value “+2”, “+1”, “0”, “−1” or “−2”. In one such embodiment, the accumulation result of the output signal 232 will not be influenced by the integration of the pseudorandom signal 234, and can be used to obtain the equivalent level V_{EQ136} of the input signal 136 properly. For example, the digital filter 208 can accumulate the output signal 232 so as to generate the digital signal 254 indicative of the equivalent level V_{EQ136}.

In one embodiment, the signal conversion system 200 further includes a controller 250 for enabling/disabling the dithering operation that is performed based on the pseudorandom signal 234. More specifically, the controller 250 can enable/disable the compensation module 106 according to the output signal 254 indicative of the input signal 136.

For example, in one embodiment, if the output signal 254 indicates that the level V₁₃₆ of the input signal 136 is not less than the value V_{R}−V_{R}/M_{ACC} or not greater than the value −V_{R}+V_{R}/M_{ACC}, e.g., |V₁₃₆|≧V_{R}−V_{R}/M_{ACC}, the controller 250 can generate a control signal 258 to disable/terminate the compensation module 106. More specifically, since the absolute value |V₂₃₄| is equal to V_{R}/M_{ACC}, if the absolute value |V₁₃₆| is not less than the value V_{R}−V_{R}/M_{ACC}, the following equation can be obtained:

|V₁₃₆|+|V₂₃₄|≧V_{R}. (19)

When the levels V₁₃₆ and V₂₃₄ both are positive or negative, equation (19) can be rewritten as:

|V₁₃₆|+|V₂₃₄|=|V₁₃₆+V₂₃₄|=|V₁₂₂|>V_{R}. (20)

As such, the values V₁₂₂+V_{R} and V₁₂₂−V_{R} may be both positive or negative, which means the integrator 212 may integrate either only a positive level V₂₂₄ or only a negative level V₂₂₄. Consequently, the threshold detector 212 may generate either only digital signals “1” or only digital signals “0”, such that the output signal 228 may not be able to indicate the input signal 122 properly.

Advantageously, the controller 250 can disable/terminate the dithering operation when the controller 250 detects that the absolute value |V₁₃₆| is not less than the value V_{R}−V_{R}/M_{ACC}. As such, in one embodiment, when the dithering operation is enabled, a magnitude, e.g., |V_{R}/M_{ACC}|, of the pseudorandom signal 234 can be relatively large, e.g., V_{R}/20, V_{R}/16, so as to make the input signal 122 of the sigma-delta ADC 102 relatively busy. By application of the controller 250, the pseudorandom signal 234 having a relatively large magnitude will not influence a normal input range, e.g., from −V_{R} to V_{R}, of the input signal 136.

In one embodiment, if the output signal 254 indicates that the level V₁₃₆ of the input signal 136 is substantially constant and the absolute value |V₁₃₆| is less than the value V_{R}−V_{R}/M_{ACC}, the controller 250 can generate the control signal 258 to enable the dithering operation. More specifically, the controller 250 can obtain a value V₁ of the equivalent level V_{EQ136} during a first sampling period T₁ (T₁=T_{SAM}), and a value V₂ of the equivalent level V_{EQ136} during a second sampling period T₂ (T₂=T_{SAM}). The second sampling period T₂ can be the next sampling period of the first sampling period T₁. The controller 250 can determine whether a difference between the values V₁ and V₂ is within a predetermined range, e.g., [−ΔV, ΔV]. If the difference between the values V₁ and V₂ is within the predetermined range, e.g., |V₂−V₁|<ΔV, it can indicate that the level V₁₃₆ of the input signal 136 is substantially constant, such that the controller 250 can enable the compensation module 106 to perform the dithering operation. In one embodiment, the controller 250 can also determine whether the level V₁₃₆ is substantially constant, in a similar manner, according to values of the equivalent level V_{EQ136} during previous sampling periods, e.g., sampling periods before the first sampling period T₁.

Furthermore, in one embodiment, if the output signal 254 indicates that the level V₁₃₆ of the input signal 136 is not substantially constant, e.g., is relatively busy, and the absolute value |V₁₃₆| is less than the value V_{R}−V_{R}/M_{ACC}, the dithering operation of the compensation module 106 can be enabled or disabled.

In the example of FIG. 2, the signal converter 244 can adjust the compensation signal 252 to a level V_{R} or −V_{R} according to the PN 256. In addition, the scaling circuit 246 can scale the level V₂₅₂ down to a level V₂₅₂/M_{ACC}, so as to provide the first compensation signal 234. However, in another embodiment, the signal converter 244 can adjust the level V₂₅₂ to V_{R}/M_{ACC} or −V_{R}/M_{ACC} according to the PN 256. In one such embodiment, the scaling circuit 246 is eliminated. The signal converter 244 can provide the compensation signal 252 to the adder 210 directly.

As mentioned above, in one embodiment, the exclusive OR gate 242 can be used to generate the PNs 256 according to the output signal 228 and the PNs 130. However, in another embodiment, the PN generator 104 can be coupled to the signal converter 244 and the ACC 248 directly, so as to provide the PNs 130 to the signal converter 244 and the ACC 248. In one such embodiment, the exclusive OR gate 242 is eliminated. Furthermore, in one embodiment, the PN generator 104 is a 1-bit PN generator. In another embodiment, the PN generator 104 is a multi-bit PN generator. In one such embodiment, the multi-bit PN generator 104 can generate multi-bit PNs 130 to the signal converter 244 and the ACC 248. The compensation signal 252 can have two or more levels and can be adjusted to a corresponding level according to the multi-bit PN 130. A DDC can convert the multi-bit PNs 130 to corresponding signed digital signals. Thus, the ACC 248 can accumulate the corresponding signed digital signals, and generate the second compensation signal 238 according to the accumulation.

In the example of FIG. 2, the adder 210 can be used to add the compensation signal 234 to the input signal 136, and the subtracter 240 can be used to subtract the compensation signal 238 from the output signal 228. However, in another embodiment, a separate subtracter can replace the adder 210 so as to subtract the compensation signal 234 from the input signal 136, and a separate adder can replace the subtracter 240 so as to add the compensation signal 238 to the output signal 228. In one such embodiment, the compensation module 106 can add a first compensation signal having an inverted level of the compensation signal 234 to the input signal 136, and can subtract a second compensation signal having an inverted level of the compensation signal 238 from the output signal 228.

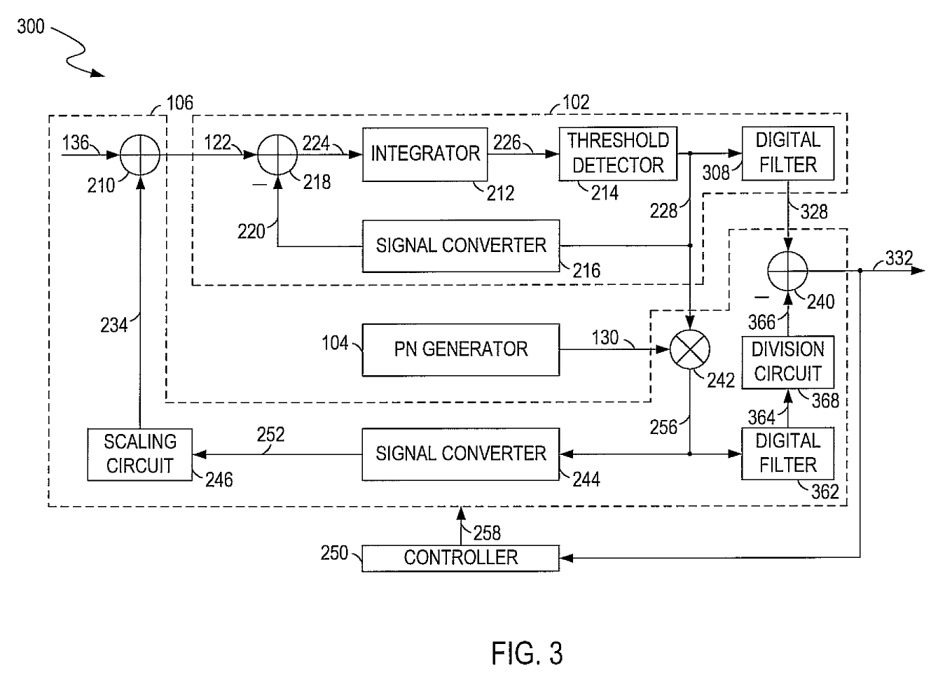

FIG. 3 depicts a block diagram of another example of a signal conversion system 300, in accordance with one embodiment of the present invention. Elements that are labeled the same as in FIG. 1 and FIG. 2 have similar functions and will not be repetitively described herein. In the example of FIG. 3, the sigma-delta ADC 102 can convert the input signal 136 to an output signal 328, e.g., a digital signal. In one embodiment, the output signal 128 in FIG. 1 includes the output signal 328 in FIG. 3. For example, the compensation module 106 can add the first compensation signal 234 to the input signal 136 and subtract a second compensation signal 366 from the output signal 328.

In one embodiment, the threshold detector 214 can be coupled to a digital filter 308. In one such embodiment, the digital filter 308 includes a DDC for converting a plurality of digital signals 228 to a plurality of signed digital signals respectively. As such, the digital filter 308 can accumulate the signed digital signals indicative of the digital signals 228, and generate the output signal 328 to indicate the value N₁−N₀. In one embodiment, the value of the output signal 328 is equal to the value N₁−N₀. In other words, the value of the output signal 328 can indicate the equivalent level V_{EQ122} of the input signal 122, e.g., V_{EQ122}=V_{R}×(N₁−N₀)/N_{SAM}.

As shown in FIG. 3, the compensation module 106 can include a digital filter 362 for receiving a predetermined number, e.g., N_{SAM}, of PNs 256 and for generating the second compensation signal 366 according to an accumulation result of the PNs 256. Similarly to the digital filter 308, the digital filter 362 can include a DDC for converting a plurality of digital signals 256 to a plurality of signed digital signals respectively. The digital filter 362 can accumulate the signed digital signals indicative of the digital signals 256, and generate a compensation signal 364, e.g., a digital signal, to indicate the value N′₁−N′₀. In one embodiment, the value of the digital signal 364 is equal to N′₁−N′₀.

In one embodiment, a division circuit 368 can receive the digital signal 364 and generate the digital signal 366 having a value N₃₆₆ that is equal to a value N₃₆₄ of the digital signal 364 divided by M_{ACC}, e.g., N₃₆₆=N₃₆₄/M_{ACC}. As such, in one such embodiment, the value N₃₆₆ of the digital signal 366 can be equal to (N′₁−N′₀)/M_{ACC}. In other words, the value of the second compensation signal 366 can indicate the equivalent level V_{EQ234} of the first compensation signal 234, e.g., V_{EQ234}=(N′₁−N′₀)×V_{R}/(M_{ACC}×N_{SAM}). The division circuit 368 can be implemented inside or outside the digital filter 362.

As shown in FIG. 3, the subtracter 240 can subtract the digital signal 366 from the digital signal 328, so as to generate an output signal 332 that is equal to the digital signal 328 minus the digital signal 366. In one embodiment, the output signal 132 in FIG. 1 includes the output signal 332 in FIG. 3. A value N₃₃₂ of the output signal 332 can be given by:

N₃₃₂=(N₁−N₀)−(N′₁−N′₀)/M_{ACC}. (21)

As such, according to equations (17b) and (21), the equivalent level V_{EQ136} of the input signal 136 can be obtained properly by using the output signal 332, e.g.,

V_{EQ136}=V_{R}×N₃₃₂/N_{SAM}.

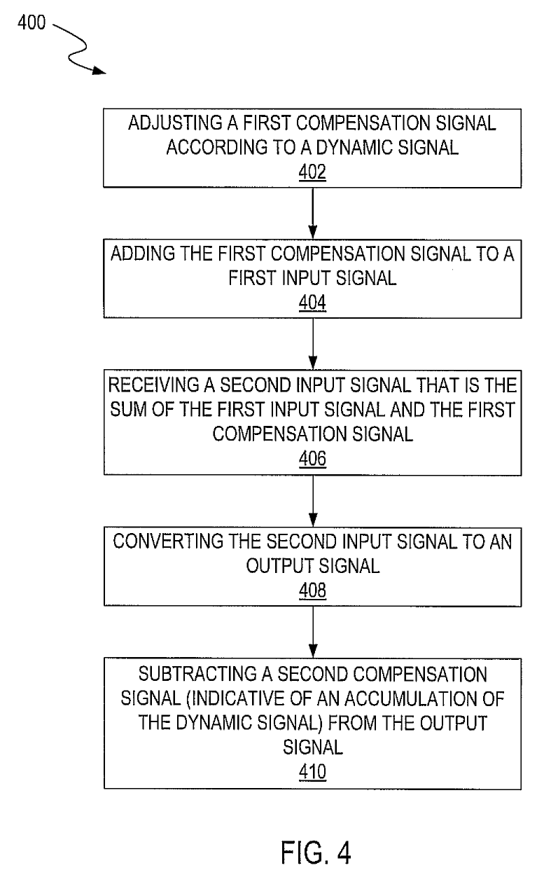

FIG. 4 depicts a flowchart 400 of examples of operations performed by a signal conversion system, in accordance with one embodiment of the present invention. FIG. 4 is described in combination with FIG. 1, FIG. 2 and FIG. 3.

In block 402, the compensation module 106 can adjust a first compensation signal 234 according to a dynamic signal 130. The dynamic signal 130 can be a PN generated by a PN generator 104. A level V₂₃₄ of the first compensation signal 234 can be adjusted according to the PN 130. As such, the first compensation signal 234 can be a pseudorandom signal.

In block 404, the compensation module 106 can add the first compensation signal 234 to a first input signal, e.g., the input signal 136. As such, the first compensation signal 234 can make the input signal 122 that is the sum of the input signal 136 and the pseudorandom signal 234 relatively busy. Thus, idle tone and flat zone issues of the sigma-delta ADC 102 can be reduced.

In block 406, the conversion module 102 can receive a second input signal, e.g., the input signal 122. In block 408, the conversion module 102 can convert the second input signal 122 to an output signal, e.g., the output signal 128 in FIG. 1, the output signal 228 in FIG. 2 or the output signal 328 in FIG. 3. In one embodiment, the conversion module 102 is a sigma-delta ADC.

In block 410, the compensation module 106 can subtract a second compensation signal (indicative of an accumulation of the dynamic signal 130) from the output signal. In the example of FIG. 2, the subtracter 240 can subtract the second compensation signal 238 from the output signal 228, and generate the output signal 232 that is equal to the output signal 228 minus the second compensation signal 238. An accumulation result of the output signal 232 can indicate, e.g., be proportional to, an equivalent level V_{EQ136} of the input signal 136. In the example of FIG. 3, the subtracter 240 can subtract the second compensation signal 366 from the output signal 328, and generate the output signal 332 that is equal to the output signal 328 minus the second compensation signal 366. A value of the output signal 332 can indicate, e.g., be proportional to, an equivalent level V_{EQ136} of the input signal 136.

Accordingly, embodiments according to the present invention provide a signal conversion system for generating an output signal to indicate an input signal based on a dithering operation. Advantageously, the dithering operation can be performed by relatively simple and/or relatively low cost elements, e.g., an LFSR, a 1-bit DAC, an ACC, etc. The signal conversion system can be used in many different applications, e.g., signal measurement systems, signal monitoring systems, etc.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An electronic system comprising:
a compensation module operable for adjusting a first compensation signal according to a dynamic signal, for adding said first compensation signal to a first input signal, and for subtracting a second compensation signal from an output signal, wherein said second compensation signal is indicative of an accumulation of said dynamic signal; and
a conversion module coupled to said compensation module and operable for receiving a second input signal that is the sum of said first input signal and said first compensation signal, and for converting said second input signal to said output signal.

2. The electronic system as claimed in claim 1, wherein said conversion module comprises an ADC (analog to digital converter).

3. The electronic system as claimed in claim 1, wherein said conversion module comprises:
an integrator operable for integrating a first signal calculated according to said second input signal and a second signal, and for generating an integral signal according to the integration;
a threshold detector coupled to said integrator and for comparing a level of said integral signal with a predetermined threshold, and for generating said output signal according to the comparison; and
a signal converter coupled to said threshold detector and operable for providing said second signal, and for adjusting a level of said second signal according to said output signal.

4. The electronic system as claimed in claim 1, further comprising:
a PN (pseudorandom number) generator operable for generating a plurality of PNs, wherein a level of said first compensation signal is adjusted according to a corresponding PN of said PNs.

5. The electronic system as claimed in claim 1, further comprising:
an LFSR (linear feedback shift register) operable for generating a plurality of PNs, wherein a level of said first compensation signal is adjusted according to a corresponding PN of said PNs.

6. The electronic system as claimed in claim 1, wherein said dynamic signal comprises a PN.

7. The electronic system as claimed in claim 1, wherein said compensation module comprises a signal converter operable for providing said first compensation signal and for adjusting a level of said first compensation signal according to said dynamic signal.

8. The electronic system as claimed in claim 1, wherein said first compensation signal comprises an analog signal.

9. The electronic system as claimed in claim 1, wherein said compensation module comprises an accumulator operable for accumulating a plurality of PNs and for generating said second compensation signal when a result of said accumulation reaches a predetermined value.

10. The electronic system as claimed in claim 1, wherein said compensation module comprises a digital filter operable for receiving a predetermined number of PNs and for generating said second compensation signal according to an accumulation result of said PNs.

11. The electronic system as claimed in claim 1, wherein said second compensation signal comprises a digital signal.

12. A method for signal conversion comprising:
adjusting a first compensation signal according to a dynamic signal;
adding said first compensation signal to a first input signal;
receiving a second input signal that is the sum of said first input signal and said first compensation signal;
converting said second input signal to an output signal; and
subtracting a second compensation signal from said output signal, wherein said second compensation signal is indicative of an accumulation of said dynamic signal.

13. The method as claimed in claim 12, further comprising:
converting said second input signal to said output signal by an ADC (analog to digital converter).

14. The method as claimed in claim 12, further comprising:
calculating a first signal according to said second input signal and a second signal;
generating an integral signal by integrating said first signal;
comparing a level of said integral signal with a predetermined threshold;
generating said output signal according to the comparison; and
adjusting a level of said second signal according to said output signal.

15. The method as claimed in claim 12, further comprising:
generating a plurality of PNs (pseudorandom numbers) by a PN generator; and
adjusting a level of said first compensation signal according to a corresponding PN of said PNs.

16. The method as claimed in claim 12, wherein said dynamic signal comprises a PN.

17. The method as claimed in claim 12, further comprising:
accumulating a plurality of PNs; and
generating said second compensation signal when a result of said accumulation reaches a predetermined value.

18. The method as claimed in claim 12, further comprising:
receiving a predetermined number of PNs; and
generating said second compensation signal according to an accumulation result of said PNs.

19. An electronic system comprising:
a signal generator operable for generating a dynamic signal;
a compensation module coupled to said signal generator and operable for adjusting a first compensation signal according to said dynamic signal, and for adding said first compensation signal to a first input signal, and for providing a second input signal that is the sum of said first input signal and said first compensation signal to a conversion module, and for subtracting a second compensation signal from an output signal of said conversion module, wherein said second compensation signal is indicative of an accumulation of said dynamic signal.

20. The electronic system as claimed in claim 19, wherein said conversion module comprises an ADC (analog to digital converter) operable for converting said second input signal to said output signal.

21. The electronic system as claimed in claim 19, wherein said signal generator comprises a pseudorandom signal generator operable for generating said dynamic signal.

22. The electronic system as claimed in claim 19, wherein said signal generator comprises an LFSR (linear feedback shift register) operable for generating a plurality of PNs (pseudorandom numbers).

23. The electronic system as claimed in claim 19, wherein said compensation module comprises a signal converter operable for providing said first compensation signal and for adjusting a level of said first compensation signal according to said dynamic signal.

24. The electronic system as claimed in claim 19, wherein said first compensation signal comprises an analog signal.

25. The electronic system as claimed in claim 19, wherein said compensation module comprises an accumulator operable for accumulating a plurality of PNs and for generating said second compensation signal when a result of said accumulation reaches a predetermined value.

26. The electronic system as claimed in claim 19, wherein said compensation module comprises a digital filter operable for receiving a predetermined number of PNs and for generating said compensation signal according to an accumulation result of said PNs.

27. The electronic system as claimed in claim 19, wherein said compensation signal comprises a digital signal.
